(19) United States
(12) Patent Application Publication
(10) Pub. No.: US 2012/0064391 A1
(43) Pub. Date: Mar. 15, 2012

(54) SEALED BATTERY

(75) Inventors: Atsushi FUKAYA, Obu-shi (JP); Teruhiko Kameoka, Okazaki-shi (JP)

(73) Assignee: DENSO CORPORATION, Kariya-city (JP)

(21) Appl. No.: 13/231,024

(22) Filed: Sep. 13, 2011

(30) Foreign Application Priority Data
Sep. 14, 2010 (JP) 2010-205529

(51) Int. Cl. H01M 2/02

(52) U.S. Cl. 429/163

(57) ABSTRACT

In a sealed battery, an outer case made of metal has a flange part and a concave part. An electric power generating element has an electrode body and electrolyte stored in the concave part. The electrode body has positive and negative electrodes connected to corresponding electrode leads, respectively. The flange part extends from the outer periphery of the outer case to the outside. The concave part is covered and sealed by a metal plate. The metal plate and one surface of the flange part are thermally bonded together through a metal-adhesive resin film. The metal plate projects toward the outside of the flange part. This projected part of the metal part is bent with the metal adhesive resin film toward the other surface of the flange part. The bent metal part and the other surface of the flange part are thermally bonded with the metal adhesive resin film.

### CROSS-REFERENCE TO RELATED APPLICATION

This application is related to and claims priority from Japanese Patent Application No. 2010-205529 filed on Sep. 14, 2010, the contents of which are hereby incorporated by reference.

### BACKGROUND OF THE INVENTION

1. Field of the Invention

The present invention related to sealed batteries in which a power generating element is stored and sealed in a battery case.

2. Description of the Related Art

There are various types of conventional sealed batteries. For example, Japanese patent laid open publication No. H10-289698 discloses a sealed battery which is composed of an electric power generating element and an outer case. The electric power generating element is stored in the outer case. The electric power generating element includes a positive electrode and a negative electrode. The outer case is composed of a lamination film. The lamination film is composed of a thin metal film and a thermally-adhesive resin layer. The thermally adhesive resin layers are laminated on both surfaces of the thin metal film.

FIG. 1 is a view showing a cross section of a conventional sealed battery disclosed in a patent document (1), Japanese patent laid open publication No. H10-289698.

As shown in FIG. 1, collector tabs 7 and 8 made of metal are formed in the positive electrode and the negative electrode. The collector tabs 7 and 8 are exposed to the outside of the sealed battery through collector tab leads formed in the sealed battery. The collector tab leads are thermally adhesive and sealed with modified resin layers 9 and 10 having thermally-adhesive characteristics. The outer case stores both the modified resin layers 9 and 10.

In particular, the modified resin layers 9 and 10 are made of carboxylic acid modified polyethylene (acid modified PE) or carboxylic acid modified polypropylene (acid modified PP). In general, the thermally adhesive resin formed in the inside of the outer case has a low adhesion with the collector tabs (which are made of metal) because the collector tabs in a conventional sealed battery are made of polyethylene (PE) or polypropylene (PP). Because the conventional technique disclosed in the patent document (1) uses acid modified PE or acid modified PP, it is possible to increase the adhesion between the collector tabs 7 and 8 and the outer case composed of a lamination film. This increases the sealing function of the sealed battery.

FIG. 2A is a perspective view showing a profile of a conventional sealed battery disclosed in a patent document (2), Japanese patent No. 3527858. FIG. 2B is a view showing a cross section of the conventional sealed battery along the line A1-A2 shown in FIG. 2A.

As shown in FIG. 2A and FIG. 2B, the conventional sealed battery is comprised of a battery body 2, a package 7 and lead terminals 12. The battery body 2 is composed of a positive electrode, a negative electrode and a separator. The battery body 2 is sealed with electrolyte solution (not shown) in the package 7. The lead terminals 12 are exposed to the outside of the package 7. The package 7 is composed of a lamination sheet (or a lamination film) 6 of a box shape and a lamination sheet 4 of a flat shape. The box-shaped lamination sheet 6 and the plane-shaped lamination sheet 4 are bonded together. The box-shaped lamination film 6 stores the battery body 2 therein.

The package 7 is composed of a battery body storing part 11 and a seal part 14. The battery body storing part 11 stores the battery body 2 and the seal part 14 extends from the battery body storing part 11. The seal part 14 has a wide shape. This structure makes it possible to completely seal the battery body 2 from water for a long period of time.

The seal part 14 is bent toward a vertical direction at the boundary part between the battery body storing part 11 along a direction which is in parallel to the longitudinal part of the package 7. A front part of the bent part of the seal part 14 is further bent toward a bottom direction so that the front part thereof is lower in height than the battery body storing part 11.

FIG. 3 is a perspective view showing a profile of another conventional sealed battery disclosed in the patent document (2).

That is, the seal part 14 of the lamination sheet 6 of a box shape is bent approximately in a vertical direction toward the battery body storing part 11, and a front part of the bent seal part 14 is bent in an opposition direction, as indicated by reference number 16 shown in FIG. 3. Thus, the bent part 16 is curled or rolled. This structure of the seal part 14 of the lamination part 16 makes it possible to suppress the area of the seal part 14 from being increased when the seal part 14 has a wide shape. It is therefore possible for the package 7 to maintain the sealing function of the battery body and to increase a volume energy density of the battery body 2.

There is another conventional battery disclosed in another patent document (3), Japanese patent laid open publication No. 2004-6124.

FIG. 4A is a perspective view showing a profile of the conventional sealed battery disclosed in the patent document (3). FIG. 4B is a view showing a cross section of the conventional sealed battery along the line A3-A4 shown in FIG. 4A.

As shown in FIG. 4A and FIG. 4B, in the sealed battery disclosed in the patent document (3), an electric power generating element is sandwiched between an outer cover pair made of metal. The outer cover pair acts as a positive electrode and a negative electrode. A metal adhesive film is placed between the outer cover pair in order to completely seal the outer cover pair together. The metal adhesive film is made of polypropylene (PP), polyethylene (PE), or carboxylic acid modified polypropylene (acid modified PP), or carboxylic acid modified polyethylene (acid modified PE). Because this structure does not require having any projection part in the outer cover pair which acts as a metal terminal, it is thereby possible to increase the sealing capability from water and to eliminate the steps of sealing the terminals and to provide a method of producing the sealed battery with high efficiency.

FIG. 5 is a view showing a cross section of a conventional sealed battery disclosed in a patent document (4), Japanese patent laid open publication No. H11-102675.

As shown in the cross section of FIG. 5, in the sealed battery disclosed in the patent document (4), a lithium metal 24 and a separator 23 and a positive electrode agent 22 are sandwiched between a positive electrode collector body 21 and a negative electrode collector body 25. The outer periphery of the positive electrode collector body 21 and the negative electrode collector body 25, which face to each other, is filled and sealed with adhesive 26 made of sealing resin.

FIG. 6 is a view showing a cross section of a conventional sealed battery disclosed in a patent document (5), Japanese patent laid open publication No. 2005-129913.

As shown in the cross section of FIG. 6, the sealed battery disclosed in the patent document (5) has an electric power generating element 10, a pair of collectors 70 and a sealing member 56. The electric power generating element 10 has a pair of electrodes 20 and 40, and an electrolyte placed between the electrode pair 20 and 40. The electric power generating element 10 is sandwiched between the collector pair 70. The collector pair 70 is sealed with the sealing member 56. The sealing member 56 is composed of a resin layer pair 50 and a thermoplastic polymer layer 52. The resin layer pair 50 is formed and hardened on the surfaces of the collector pair 70. The hardened resin layers 50 are bonded together by the thermoplastic polymer layer 52.

The sealed battery disclosed in each of the patent documents (4) and (5) has a sealing member to improve the sealing characteristics of the outer periphery of the outer case. This structure makes it possible to provide a high sealing capability and to prevent water from entering into the inside of the sealed battery, and the inner resistance and deterioration of the sealed battery characteristics from being increased caused by water entering and decreasing the battery capacity.

FIG. 7 is a view showing a cross section of a conventional sealed battery disclosed in a patent document (6), Japanese patent laid open publication No. 2003-288863.

The sealed battery disclosed in the patent document (6) has an outer box 1a and a cover member 3a. The outer box 1a is made of aluminum or lamination film in which an electric power generating element 2a is stored. The cover member 3a covers the outer box 1a. Further, an uneven shape such as ribs, fins and/or dimples is formed on at least one of the cover member 3a and a plate part 21a having the maximum area in the outer box 1a and the cover member 3a. Still further, the outer periphery of the outer box 1a is sealed with a heat seal or an insulation gasket is formed at the outer periphery of the outer box 1. This structure makes it possible to increase radiation efficiency to provide the sealed battery with enough safety against various damages such as mechanical and thermal damage and because the outer box 1a or the cover member 3a has an uneven structure.

By the way, in the conventional sealed battery disclosed in the patent document (1), because chemical adhesion (hydrogen bonding force) bonds the outer case to the collector tabs 7 and 8 together, this structure provides the usual sealing function even if the sealed battery is used at a high temperature condition for a long period of time when compared with a usual low adhesive structure. However, when this structure of the conventional sealed battery is applied to special batteries such as a lithium battery, gas is generated in the sealed battery. The more such a gas is generated in the sealed battery, the more the internal pressure of the sealed battery is increased. Because the increased internal stress damages the modified resin layers 9 and 10, deformation, namely, creeps are generated in the modified resin layers 9 and 10 due to the increased internal stress. The generation of such creeps breaks the modified resin layers 9 and 10. The sealing capability of the sealed battery is thereby damaged. In particular, in the structure of the sealed battery disclosed in the patent document (1), because the seal part of the lamination films around the periphery of the outer case is made through the modified resin layers 9 and 10 which are made of polypropylene (PP) (or polyethylene (PE)), these modified resin layers 9 and 10 are broken by such creeps generated when gas is generated in the inside of the sealed battery.

The above phenomenon such as breaking is also generated in the sealed battery disclosed in the patent document (2).

FIG. 8 is a view showing a cross section which explains a problem of the conventional sealed battery shown in FIG. 2A and FIG. 2B, as disclosed in the patent document (2).

That is, as shown in FIG. 8, a front part of the lamination films A1 with which the polypropylene (PP) is sandwiched is bent and the front part of the lamination films A1 is further bent. When a stress is generated according to the generation of gas in the sealed battery, it is possible to delay the time at which the polypropylene (PP) is broken by generated creeps. However, because the front of the bent part in the lamination films A1 has a gap designated by reference arrow Y1 shown in FIG. 8, the structure of the front of the bent part of the lamination films A1 and the corresponding polypropylene (PP) is independently from the other non-bent lamination films A1. Accordingly, this structure having the gap Y1 can delay the time when the sealed battery is broken by creeps generated, but not prevent the sealed battery from being broken by the creeps.

In the sealed battery disclosed in the patent document (3), because the outer cover pair is made of metal plate, this structure can prevent the stress generated by gas when the metal plate has a thicker, but has a drawback of increasing the entire weight of the sealed battery.

Because the sealed battery disclosed in each of the patent documents (4) and (5) has a heat sealing structure in which the outer periphery of the positive electrode collector body 21 and the negative electrode collector body 25 is sealed with seal resin, the sealing capability is deteriorated by creeps generated in the seal resin when the inner pressure of the sealed battery is gradually increased according to long term use of the sealed battery. This decreases the sealing capability and finally causes breaking of the sealed battery.

The sealed battery disclosed in the patent document (6) has the structure in which the outer periphery of the outer box 1a is sealed with heat seal made of seal resin or the insulation gasket is placed around the outer periphery of the outer box 1a and caulked by a predetermined pressure. This decreases the sealing capability by creeps generated in the seal resin when the inner pressure of the sealed battery is increased by long term use, and finally breaks the sealed battery. Further, the insulation gasket itself generates creep therein when receiving the pressure by the caulking. Even if the outer periphery of the outer box la is sealed by welding, this requires an additional working step and increases the manufacturing cost.

### SUMMARY OF THE INVENTION

It is an object of the present invention to provide a sealed battery without increasing the entire weight and manufacturing cost thereof, having a structure in which an outer periphery of an outer case, which stores an electric power generating element, is sealed so as to prevent creeps from being generated in the outer periphery of the outer cover by the stress increased when gas is generated in the sealed battery and an internal pressure of the sealed battery is thereby increased.

To achieve the above purpose, the present exemplary embodiment provides a sealed battery having an electric power generating element, a positive electrode lead, a negative electrode lead, an outer case, and a metal plate. The electric power generating element has an electrode body, electrolyte and a positive electrode and a negative electrode. The positive electrode lead is electrically connected to the positive electrode. The negative electrode lead is electrically connected to the negative electrode. The outer case is made of metal and has a flange part and a concave part. The flange part extends from the outer periphery of the outer case to the outside thereof. The concave part stores the electric power generating element therein. The metal plate covers the concave part of the outer case in order to seal the concave part. The metal plate and the flange part are thermally bonded together through a metal adhesive resin film placed between the surface of the flange part and the metal plate. In particular, the thermally-bonded part between the metal plate and the flange part of the outer case has a lamination structure in which the metal plate is comprised of at least not less than three metal layers, and the flange part and the metal layer are alternately stacked through the metal adhesive resin film.

Because the sealed battery having the above structure has at least not less than three metal layers, the metal plate is thermally bonded on both the surfaces of the flange part of the outer case through the metal adhesive resin film. In other words, the metal plate which seals the concave part of the outer case is thermally bonded on one surface (bottom surface) of the flange part of the outer case through the metal adhesive resin film, and further is thermally bonded on the other surface (upper surface) of the flange part of the outer case through the metal adhesive resin film. The more the number of the metal layers is increased more than three, the metal plate is bent and thermally bonded on the upper and bottom surfaces of the flange parts through the metal adhesive resin film. When compared with the structure of a conventional sealed battery in which the metal plate is bonded only to one surface of the flange part with a metal adhesive resin film, the structure of the sealed battery according to the exemplary embodiment of the present invention can increase the bonding force between the metal plate and the flange part of the outer case, and increase the force against the stress of the inner pressure of the concave part when gas is generated in the concave part of the outer case.

That is, in the structure of the conventional sealed battery, gas is generated from the electric power generating element stored in the concave part of the outer case and the generated gas increases an internal pressure of the concave part. There is a possibility of generating creeps by the increased internal pressure and separating the flange part from the metal plate or breaking the flange part and the metal plate by the generated creeps and internal pressure.

On the other hand, the sealed battery according to the exemplary embodiment of the present invention has a plurality, of layers in which the metal plate is bent and thermally bonded on each surface of the flange part through the metal adhesive resin film. This structure having a plurality of the metal layers can increase the bonding force between the metal plate and the flange part and the increased bonding force can prevent the increased internal pressure of the concave part when gas is generated. This makes it possible to prevent the separation between the flange part and the metal plate and to prevent the flange part and the metal plate from being broken. Still further, because it is possible to easily make the structure having a plurality of the metal layers in which the metal plate is thermally bond on each of the upper surface and the bottom surface of the flange part through the metal adhesive resin film, it is possible to produce the sealed battery without increasing the entire weight and a manufacturing cost thereof.

In accordance with another exemplary embodiment of the present invention, there is provided a sealed battery having an electric power generating element, positive electrode lead, a negative electrode lead, an outer case, and a metal plate. The electric power generating element has an electrode body, electrolyte and a positive electrode and a negative electrode. The positive electrode lead is electrically connected to the positive electrode. The negative electrode lead is electrically connected to the negative electrode. The outer case is made of metal. The outer case has a flange part and a concave part. The flange part extends from the outer periphery of the outer case to the outside. The concave part stores the electric power generating element. The metal plate covers the concave part of the outer case in order to seal the concave part. The metal plate and one surface of the flange part are thermally bonded together through a metal adhesive resin film placed between the surface of the flange part and the metal plate. In particular, the metal plate projects toward the outside of the flange part. The projected part of the metal part with the metal adhesive resin film is bent toward the other surface of the flange part. The bent part of the metal part and the other surface of the flange part are thermally bonded through the metal adhesive resin film.

When compared with a structure of a conventional sealed battery in which the metal plate is thermally bonded only to the bottom surface of the flange part through the metal adhesive resin film, because the sealed battery according to the exemplary embodiment of the present invention has the structure in which the projected part of the metal plate toward the flange part is further bent on the upper surface of the flange part and is thermally bonded to the upper surface of the flange part through the metal adhesive resin film, it is possible for the sealed battery to have an increased bonding force between the metal plate and the flange part. The structure of the sealed battery according to the present invention can solve the conventional drawbacks of generating creeps in the concave parts and the metal plate when gas is generated in the concave part of the outer case, and of separating the metal plate from the flange part by the generated creeps or of breaking the metal plate and the flange part by the generated creeps.

On the other hand, in the structure of the sealed battery according to the present invention, because the metal plate which is bent on the bottom surface and the upper surface of the flange part is thermally bonded to the surfaces through the metal adhesive resin film, it is possible for the sealed battery to have the increased mechanical strength against the stress generated by the increased inner pressure of the concave part. The increased mechanical strength makes it possible to prevent the flange part from being separated from the metal plate, and to prevent the flange part and the metal plate from being broken.

Still further, the structure of the sealed battery according to the present invention is obtained by bending the metal plate (which is extended toward the outside of the flange part from the bottom surface of the flange part) toward the upper surface side of the flange part and thermally bonded to the upper surface of the flange part through the metal adhesive resin film. This structure makes it possible to produce the sealed battery almost without increasing the entire weight and manufacturing cost.

In the structure of the sealed battery according to the exemplary embodiment, the metal plate and the outer case are made of one metal selected from aluminum, stainless steel, copper, nickel, and nickel plated copper.

This structure makes it possible to increase the strength of the sealed battery itself.

In the structure of the sealed battery according to the exemplary embodiment, the metal plate and the outer case have a thickness within a range of 0.1 mm to 2.0 mm.

This structure makes it possible to increase the strength of the sealed battery itself without approximately increasing the entire weight of the sealed battery because each of the outer case and the metal plate does not have a thicker thickness.

In the structure of the sealed battery according to the exemplary embodiment, the surfaces of the metal plate and the flange part are made of one metal selected from chromate-treated metal, alumite treated metal, boehmite treated metal.

This structure makes it possible for the sealed battery to have an increased acid resistance and an increased alkali resistance, and a corrosion resistance capability.

On the other hand, when the flange part and the metal plate are made of metal without any treatment, both the flange part and the metal plate are corroded by acid and alkali contained in electrolyte in the sealed battery.

In the structure of the sealed battery according to the exemplary embodiment, the metal adhesive resin film is acid modified polyolefin resin.

This structure makes it possible to increase the sealing capability between the flange part and the metal plate and to decrease solubility in electrolyte. On the other hand, when the metal adhesive resin film is made of resin other than acid modified polyolefin resin, there is a possibility of having insufficient sealing function of bonding the flange part to the metal plate, and of easily dissolving the metal adhesive resin film in the electrolyte.

In the structure of the sealed battery according to the exemplary embodiment, the thermally-bonded part between one surface of the flange part and the metal plate which is bent toward one surface direction is further bent toward the other surface of the flange part and rolled with the metal adhesive resin film at least one or more times and thermally bonded together.

Because the sealing part of the outer case in which the metal adhesive resin film is sandwiched between the flange part and the metal part is bent two or more times and thermally bonded together, it is possible to increase the bonding strength of the sealing part. This makes it possible to increase the strength against the stress generated when the inner pressure of the concave part of the outer case is increased. This structure prevents the flange part from being separated from the metal part or prevents the flange part and the metal part from being broken when creeps are generated therein. Still further, because the above structure of the sealing part is obtained by bending the flange part and the metal part many times through the metal adhesive resin film and by thermally bonding them together, it is possible to produce the sealed battery with a high sealing capability without increasing the entire weight and increasing the manufacturing cost.

In the structure of the sealed battery according to the exemplary embodiment, the surface of the metal plate thermally bonded to the surface of the flange part is caulked.

Because this structure of the sealed battery increases the bonding force between the flange part and the metal plate, it is possible to more increase the strength against the stress generated when the inner pressure of the concave part is increased. This makes it possible to further prevent the flange part from being separated from the metal plate in the sealing part and to prevent the flange part and the metal plate in the sealing part from being broken.

In the structure of the sealed battery according to the exemplary embodiment, the outer case is electrically connected to one of the positive electrode and the negative electrode of the electrode body, and the electrode lead connected to the other electrode is extended from the concave part of the outer case toward the outside of the sealed battery.

In this structure of the sealed battery, when the outer case is directly connected to the positive electrode without using any positive electrode lead, the outer case acts as the positive electrode lead and the negative electrode lead projects from the outer case toward the outside of the sealed battery.

On the other hand, when the outer case is directly connected to the negative electrode without using any negative electrode lead, the outer case acts as the negative electrode lead and the positive electrode lead projects from the outer case toward the outside of the sealed battery. This structure makes it possible to decrease the manufacturing cost of making the positive electrode lead or the negative electrode lead.

In the structure of the sealed battery according to the exemplary embodiment, the outer case is electrically connected to one of the positive electrode and the negative electrode of the electrode body, and the metal plate is electrically connected to the other electrode.

In the structure of the sealed battery according to the present invention, because the outer case acts both the positive electrode lead and the negative electrode lead, it possible to decrease the manufacturing cost of making the positive electrode lead and the negative electrode lead.

In the structure of the sealed battery according to the exemplary embodiment, one surface of the outer case, which faces to the metal plate, has an uneven shape.

Because the surface of the outer case has an uneven shape, it is possible to have an increased surface area capable of radiating heat energy from the sealed battery to the outside atmosphere. Thus, this structure makes it possible to increase the cooling efficiency This structure thereby prevents the bonding force between the flange part and the metal plate from being decreased.

In the structure of the sealed battery according to the exemplary embodiment, the uneven shape of the surface of the outer case is composed of a plurality of column-shaped concave parts and column-shaped convex parts, and a height of each of the column-shaped convex parts is within a range of 0.1 mm to 2.0 mm.

Because each of the column-shaped convex parts has a height within a range of 0.1 mm to 2.0 mm in the sealed battery, it is possible to provide the highly cooling effect without decreasing the entire volume of the sealed battery.

According to the exemplary embodiment, the sealed battery is a lithium ion secondary battery.

It is possible for a lithium ion secondary battery to have the actions and effects of the sealed battery according to the present invention as previously described.

### BRIEF DESCRIPTION OF THE DRAWINGS

A preferred, non-limiting embodiment of the present invention will be described by way of example with reference to the accompanying drawings, in which:

FIG. 1 is a view showing a cross section of a conventional sealed battery;

FIG. 2A is a perspective view showing a profile of a conventional sealed battery;

FIG. 2B is a view showing a cross section of the conventional sealed battery along the line A1-A2 shown in FIG. 2A;

FIG. 3 is a perspective view showing a profile of a conventional sealed battery;

FIG. 4A is a perspective view showing a profile of a conventional sealed battery;

FIG. 4B is a view showing a cross section of the conventional sealed battery along the line A3-A4 shown in FIG. 4A;

FIG. 5 is a view showing a cross section of a conventional sealed battery;

FIG. 6 is a view showing a cross section of a conventional sealed battery;

FIG. 7 is a view showing a cross section of a conventional sealed battery;

FIG. 8 is a view showing a cross section which explains a problem of the conventional sealed battery shown in FIG. 2A and FIG. 2B;

FIG. 9 is a perspective view showing an outer structure of the sealed battery according to a first exemplary embodiment of the present invention;

FIG. 10 is a view showing a cross section of the sealed battery along the line B1-B2 shown in FIG. 9;

FIG. 11 is a view showing a flow chart of producing the sealed battery according to the first exemplar embodiment shown in FIG. 9;

FIG. 12 is a view showing a cross section of a thermally-bonded part (or a seal part) in a flange part of the outer case in the sealed battery as a first modification of the first exemplary embodiment shown in FIG. 9 and FIG. 10;

FIG. 13 is a view showing a cross section of a thermally-bonded part (or a seal part) in the flange part of the outer case in the sealed battery as a second modification of the first exemplary embodiment shown in FIG. 9 and FIG. 10;

FIG. 14 is a perspective view showing an outer structure of the sealed battery according to a second exemplary embodiment of the present invention;

FIG. 15 is a perspective view showing an outer structure of the sealed battery according to a third exemplary embodiment of the present invention;

FIG. 16 is a perspective view showing an outer structure of the sealed battery according to a fourth exemplary embodiment of the present invention;

FIG. 17 is a perspective view showing an outer structure of the sealed battery according to a fifth exemplary embodiment of the present invention; and

FIG. 18 is a perspective view showing an outer structure of the sealed battery according to a sixth exemplary embodiment of the present invention.

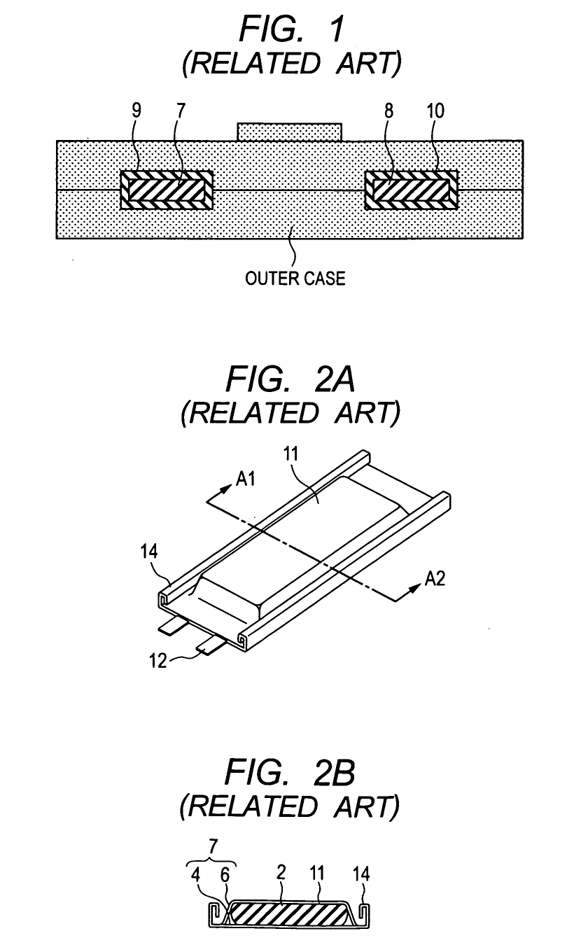

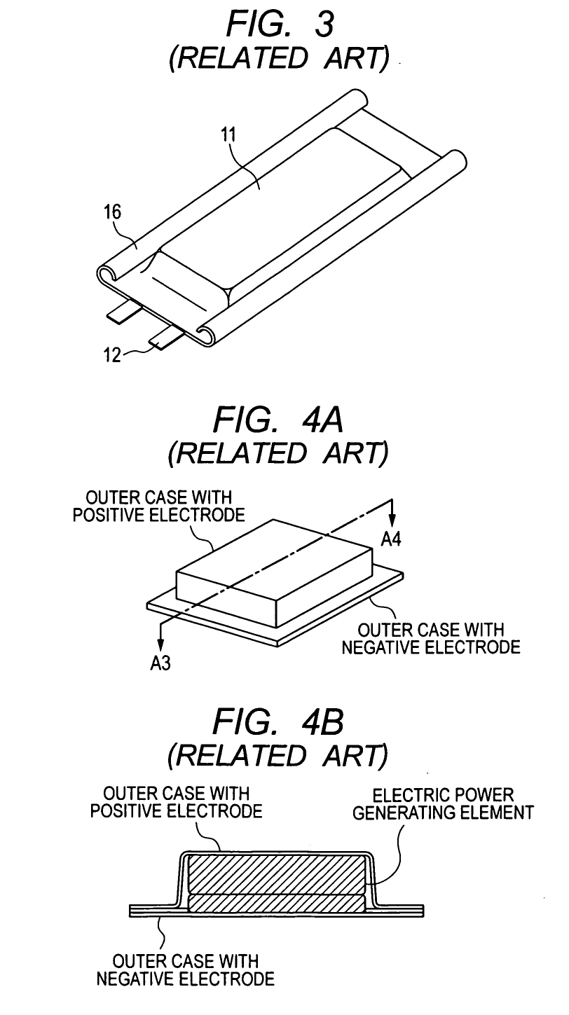

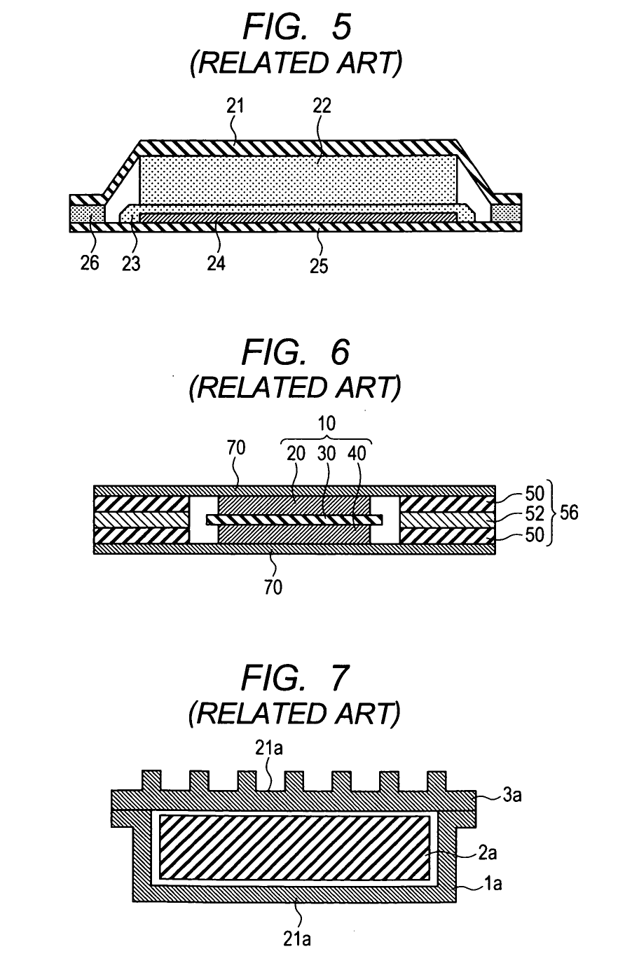

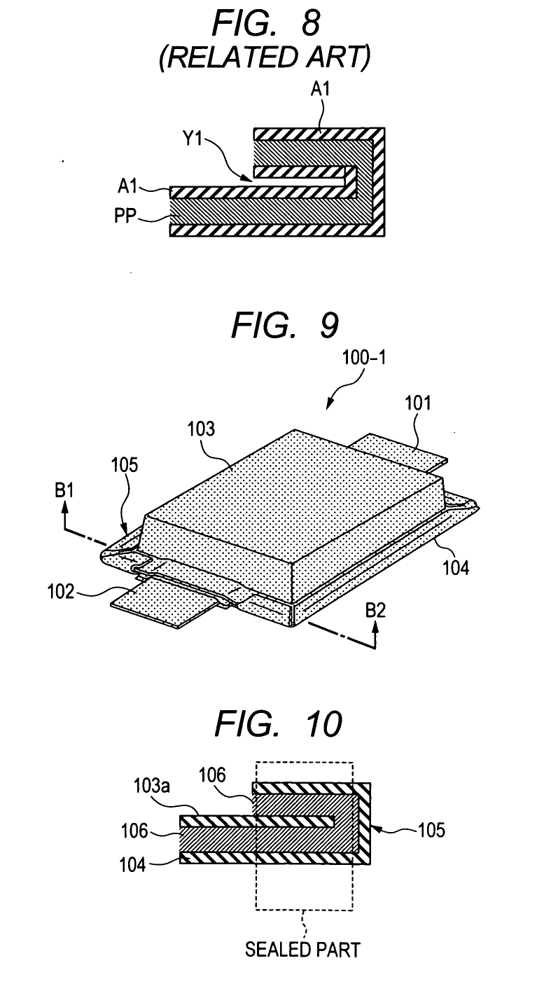

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

A description will be given of the sealed battery 100-1 according to a first exemplary embodiment of the present invention with reference to FIG. 9 to FIG. 13.

FIG. 9 is a perspective view showing an outer structure of the sealed battery 100-1 according to the first exemplary embodiment of the present invention. FIG. 10 is a view showing a cross section of the sealed battery 100-1 along the line B1-B2 shown in FIG. 9.

As shown in FIG. 9 and FIG. 10, the sealed battery 100-1 is comprised of an electric power generating element, an outer case 103 with a flange part 103a, and a metal plate 104. The electric power generating element is comprised of an electrode body and an electrolyte, and stored in the outer case 103 of a box shape. The electrode body of the electric power generating element has a positive electrode and a negative electrode. The positive electrode is electrically connected to a positive electrode lead and the negative electrode is electrically connected to a negative electrode lead. The outer case 103 has the flange part 103a, which are made of metal. The flange part 103a projects from the outer periphery of the outer peripheral part 105 of the outer case 103. The metal plate 104 is thermally bonded to the flange part 103a of the outer case 103 through a metal adhesive resin film 106 capable of bonding metal so that the concave part of the outer case 103 is completely sealed with the resin film.

In particular, as shown in FIG. 9, the positive electrode lead 101 and the negative electrode lead 102 project from the sealing part, namely, from the adhesive parts, respectively, toward in opposite directions. In the adhesive part (or the sealing part), the metal plate 104 is bonded to the side parts of the box-shaped outer case 103 so that the metal plate 104 and the outer case 103 face together. The outer case 103 and the metal plate 104 are made of metal such as aluminum, stainless, copper, nickel, or nickel plated copper. The metal adhesive resin film 106 is made of carboxylic acid modified polyethylene (acid modified PE) or carboxylic acid modified polypropylene (acid modified PP).

The sealed battery 1004 according to the first exemplary embodiment has the following features. That is, as shown in FIG. 10, the metal adhesive resin film 106 is sandwiched between the flange part 103a of the outer case 103 and the outer periphery part 105 of the metal plate 104. Further, as shown in FIG. 10, the outer peripheral part 105 of the metal plate 104 is firstly bent in a vertical direction with the metal adhesive resin film 106, and further bent them toward the flange part 103a side. The bent metal plate 104 and the flange part 103a of the outer case 103 with which the metal adhesive resin film 106 is sandwiched are thermally bonded together.

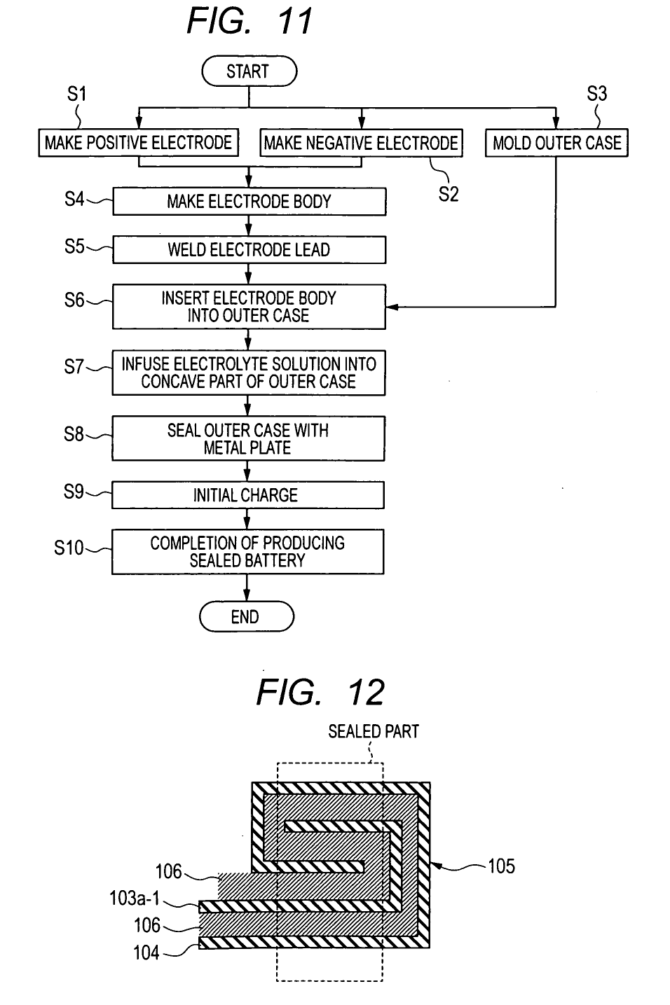

A description will now be given of the method of producing the sealed battery 100-1 having the above structure with reference to FIG. 11.

FIG. 11 is a view showing a flow chart of producing the sealed battery 100-1 according to the first exemplar embodiment shown in FIG. 9.

In step S1, a positive electrode is formed as follows.

N-methylpyrrolidone (NMP) is added into a mixture of 82 mass % of lithium iron phosphate (LiFePO₄), 10 mass % of acetylene black, 8 mass % of polyvinylidene difluoride (PVDF). The obtained mixture is uniformly dispersed to produce uniformly-dispersed paint solution. The produced uniformly-dispersed paint solution is applied on both surfaces of a collector plate made of aluminum by 50 μm. The collector plate is then dried and pressed to produce a positive electrode.

The positive electrode uses active material such as composite of lithium transition metal oxide capable of emitting lithium ions. There are as examples of such composite of lithium transition metal oxide, LiNiO₂, LiMnO₂, LiMn₂O₄, LiCoO₂, LiFeO₂, LiFePO₄, LiMnPO₄, etc. However, the concept of the present invention is not limited by the above complexes. It is possible to use one type of composite of lithium transition metal oxide or a mixture of various types of composite of lithium transition metal oxide. In particular, it is preferable to use, as composite of lithium transition metal oxide, one or more selected from composite oxide containing lithium manganese, composite oxide containing lithium nickel, composite oxide containing lithium cobalt, and composite oxide containing lithium iron.

The positive electrode layer is formed by mixing the above positive active material, water as conductive agent (electro conductive additive), and NMP as solvent and applying the mixture on the collector plate. There are, as binding agent, polyvinylidene fluoride, polytetrafluoroethylene, polyacrylic acid lithium, EPDM, SBR, NBR, fluororubber, etc. There are, as conductive agent (electro conductive additive), ketjen black, acetylene black, carbon black, graphite, carbon nanotube, amorphous carbon, etc.

In step S2, a negative electrode is formed as follows.

N-methylpyrrolidone (NMP) is added into a mixture of 98 mass % of graphite and 2 mass % of polyvinylidene difluoride (PVDF).

The obtained mixture is uniformly dispersed to produce uniformly-dispersed paint solution. The produced uniformly-dispersed paint solution is applied on both surfaces of a collector plate made of copper by 50 μm. The collector plate is then dried and pressed to produce a negative electrode.

It is possible to use a compound or a mixture of compounds capable of emitting and adsorbing lithium ions. There are, as such compound capable of emitting and adsorbing lithium ions, metal such as lithium, etc., an alloy containing silicon, tin, etc., graphite, coke, sintered body of organic polymer compound, and carbon such as amorphous carbon, etc. That is, it is possible to use a single active material or compound of active material. For example, lithium foil is used as negative active material, it is possible to press lithium foil on the surface of the collector made of metal such as copper.

Further, when an alloy or carbon material is used as negative active material, the negative electrode layer is formed by mixing the above negative active material, binding agent, conductive agent (electro conductive additive) into solvent such as water or NMP, and applying the mixture on the collector plate made of copper, etc. It is preferable to use binding agent made of polymer which is chemically and physically stable in the atmosphere of a secondary battery. For example, there are, as binding agent, polyvinylidene fluoride, polytetrafluoroethylene, polyacrylic acid lithium, EPDM, SBR, NBR, fluororubber, etc. There are, as conductive agent (electro conductive additive), ketjen black, acetylene black, carbon black, graphite, carbon nanotube, amorphous carbon, etc.

In step S3, a metal plate is pressed to make the box-shaped outer case 103 with the flange part 103a.

In step S4, an electrode body is produced. That is, a separator is inserted into and placed between the positive electrode and the negative electrode which are produced in step S1 and S2. A plurality of the laminations obtained above is stacked in order to produce a plate shaped electrode body. It is preferable to insert the separator having an electrical insulation function and an ion conductivity function between the positive electrode and the negative electrode.

When liquid electrolyte is used, such a separator can maintain the liquid electrolyte. It is preferable to use porous film or non-woven textile fabrics made of porous synthetic resin film, in particular, made of polyolefin polymer, (polyethylene, polypropylene) or glass fiber. Further, it is preferable for the separator to have a large size rather than the side of the positive electrode and the negative electrode in order to completely insulate the positive electrode and the negative electrode to each other.

In step S5, the positive electrode lead 101 and the negative electrode lead 102 are fixed to the electrode body produced in step S4 by welding.

In step S6, the electrode body with the positive electrode lead 101 and the negative electrode lead 102 is inserted into the concave part of the outer case 103.

In step S7, electrolyte solution as electrolyte is infused into the concave part of the outer cover case 103. This fills the concave part of the outer case 103 with electrolyte solution as electrolyte.

The present invention does not limit the type of electrolyte. For example, it is possible to use as electrolyte organic solvent with supporting electrolyte, ionic liquid, or ionic liquid with supporting electrolyte.

It is possible to use, as organic solvent in lithium secondary battery, carbonate compound (group), halogenated hydrocarbon, ether group, ketone group, nitrile group, lactone group, oxolane compound, etc. In particular, propylene carbonate, ethylene carbonate, 1,2-dimethoxyethane, dimethyl carbonate, diethyl carbonate, ethyl methyl carbonate, etc., or a mixture of them. It is preferable to use non-water solvent containing at least one or more selected from carbonate group and ether group in the views of solubility, dielectric constant, viscosity, and stability of supporting electrolyte. This provides a high charging and discharging efficiency of the sealed battery.

The present invention does not limit the type of ionic liquid even if it is ionic liquid to be used as electrolyte of a lithium secondary battery. For example, there are, as cation component contained in ionic liquid, N-methyl-n-propyl piperidinum, dimethyl ethyl toxi ammonium cation, etc. There is BF₄—, N(SO₂CF₃)₂—, etc., as anion component.

In addition, the present invention does not limit the type of supporting electrolyte. For example, it is possible to use, as supporting electrolyte, LiPF₆, LiBF₄, LiAsF₆, LiCF₃SO₃, LIN(CF₃SO₂)₂, LiC(CF₃SO₂)₃, LiSbF₆, LiSCN, LiClO₄, LiAlCl₄, NaClO₄, NaBF₄, NaI, and salt compound of derivative of them.

It is preferable to use in view of electric conductivity, LiPF₆, LiBF₄, LiClO₄, LiAsF₆, LiCF₃SO₃, LiN(CF₃SO₂)₂, LiC(CF₃SO₂)₃, LiN(FSO₂)₂, LiN(CF₃SO₂)(C₄F₉SO₂), a derivative of LiCF₃SO₃, a derivative of LiN(CF₃SO₂)₂, and a derivative of LiC(CF₃SO₂₎₃.

For example, ethylene carbonate (EC) and diethyl carbonate (DEC) are mixed in volume ratio of 3:7, and 1 mol/L of LiPF₆ as supporting electrolyte is added into the mixture of organic solvent to produce electrolyte solution. Adding such electrolyte can store the electrode body and the electric power generating element in the concave part formed in the inside of the outer case 103 in which the positive electrode lead 101 and the negative electrode lead 102 are electrically connected to the positive electrode and the negative electrode, respectively.

In step S8, the concave part of the outer case 103 in which the electric power generating element is stored is covered and sealed with the metal plate 104. That is, the concave part of the outer case 103 is covered with the metal plate 104 and the metal adhesive resin film 106 so that the metal adhesive resin film 106 faces the concave part of the outer case 103.

Next, as shown in FIG. 10, the outer periphery of the metal plate 104, which projects toward all of the directions observed from the flange part 103a of the outer case 103, and the metal adhesive resin film 106 are bent toward the flange part 103a side. This makes it possible to produce the sandwich structure in which the flange part 103a of the outer case 103 is sandwiched between the metal plate 104 through the metal adhesive resin film 106 on both the surfaces of the flange part 103a. That is, the flange part 103a is electrically insulated from the upper side metal plate 104 and the bottom side metal plate 104, as shown in FIG. 10. The three layer structure composed of the flange part 103a of the outer case 103, the upper side metal plate 104 and the bottom side metal plate 104 is thermally bonded together.

In step S9, the sealed battery 100-1 composed of the outer case 103 and the metal plate 104 which are sealed together are initially charged. In step S10, the production of the sealed battery 100-1 is completed.

As described above in detail, the sealed battery 100-1 according to the first exemplary embodiment has the concave part of the outer case 103 in which the electric power generating element composed of the electrode body and electrolyte are stored. The positive electrode and the negative electrode of the electrode body are electrically connected to the positive electrode lead 101 and the negative electrode lead 102, respectively. The outer case 103 has the flange part 103a which projects from the periphery of the concave part. The outer case 103 is made of metal. The metal adhesive resin film 106 is placed between the flange part 103a of the outer case 103 and the metal plate 104. The metal plate 104 and the outer case 103 are thermally bonded together through the metal adhesive resin film 106. The metal plate 104 completely covers and seals the concave part of the outer case 103 through the metal adhesive resin film 106.

The important structural feature of the sealed battery according to the first exemplary embodiment is that the metal plate 104, which is thermally bonded to the bottom surface of the flange part 103a of the outer case 103, is projected toward the outside of the flange part 103a, and the projected part of the metal plate 104 is bent toward the other surface of the flange part 103a with the metal adhesive resin film 106, and the bent part of the metal plate 104 is thermally bonded to the other surface of the flange part 103a through the metal adhesive resin film 106, as shown in FIG. 10.

This structure of the sealed battery 100-1 shown in FIG. 10 makes it possible to increase the bonding force of the metal plate 104 onto the flange part 103a of the outer case 103 because the projected part of the metal plate 104, which is projected toward the outside of the flange part 103a, is bent to the upper side of the flange part 103a and the projected part of the metal plate 104 is thermally bonded to the upper surface of the flange part 103a through the metal adhesive resin film 106.

By the way, in a sealed battery having a conventional structure, a flange part is often separated from a metal plate or the flange part and the metal plate are broken when gas is generated in the electric power generating element stored in a concave part of an outer case and an internal pressure of the concave part thereby increases because creeps are generated by increasing the internal pressure of the concave part.

On the other hand, according to the sealed battery of the first exemplary embodiment, because the metal plate 104 which is thermally boned to the flange part 103a of the outer case 103 is bent toward the upper surface of the flange part 103a with the metal adhesive resin film 106, this structure makes it possible to prevent a stress generated when the internal pressure of the concave part of the outer case 103 is increased even if gas is generated in the concave part. This provides a tight structure between the flange part 103a and the metal plate 104 and this structure makes it difficult to separate the flange part 103a from the metal plate 104, or to break them. Still further, as shown in FIG. 10, the metal plate 104 projecting toward the outside of the sealed battery 100-1 from the bottom surface of the flange part 103a is further bent toward the upper surface side of the flange part 103a. As a result, the metal plate 104 is formed on both the surfaces of the flange part 103a through the metal adhesive resin film 106, and the metal plate 104 and the flange part 103a are thermally bonded together. This structure makes it possible to produce the sealed battery 100-1 almost without increasing the entire weight and manufacturing cost.

It is preferable to use the flange part 103a and the metal plate 104 made of one metal selected from aluminum, stainless steel, copper, nickel, and nickel plated copper. This makes it possible to increase the mechanical strength of the sealed battery 100-1.

It is preferable for the flange part 103a and the metal plate 104 to have a thickness within a range of 0.1 mm to 2.0 mm. This makes it possible to increase the mechanical strength of the sealed battery 100-1. Because each of the flange part 103a and the metal plate 104 is not thick, it is possible to produce the sealed battery having the above structure almost without increasing the entire weight and manufacturing cost.

It is preferable that the surfaces of the metal plate 104 and the flange part 103 of the outer case 103 are processed by chromate treatment, alumite treatment or boehmite treatment. This makes it possible to increase corrosion resistance such as acid resistance and alkali resistance, On the other hand, when the sealed battery without any treatment is used, acid and alkali contained in electrolyte corrodes the inside surfaces of the outer case 103 and the metal plate 104 and the flange part 103a may become separated from the metal plate 104.

It is preferable to use a metal adhesive resin film 106 made of acid modified polyolefin resin. This makes it possible to increase the sealing capability between the metal adhesive resin film 106, the metal plate 104 and the flange part 103a, and to decrease solubility in electrolyte.

When the metal adhesive resin film 106 is made of resin of material other than acid modified polyolefin resin, there is a possibility that the metal adhesive resin film 106 is easily dissolved and separated from the flange part 103a and the metal plate 104.

### (First Modification)

A description will be given of a first modification of the sealed battery according to the first exemplary embodiment of the present invention with reference to FIG. 12.

FIG. 12 is a view showing a cross section of a thermally-bonded part in the flange part 103a-1 of the outer case 103 in the sealed battery as a first modification of the first exemplary embodiment shown in FIG. 9 and FIG. 10.

The structure composed of the flange part 103a-1 and the metal plate 104 shown in FIG. 12 is obtained by further bending one more time the structure composed of the flange part 103a and the metal plate 104 toward the upper surface side of the flange part 103a-1. In more detail, the front part composed of the metal plate 104 and the flange part 108a-1, which is bent on and thermally bonded to the upper surface side of the flange part 103a with the metal adhesive resin film 106, is further bent toward the upper surface side of the flange part 103a-1 with the metal adhesive resin film 106, and the bent part composed of the flange part 103a-1 and the metal plate 104 is thermally bonded together through the metal adhesive resin film 106.

The first modification of the sealed battery according to the first exemplary embodiment has the seal part (thermally-bonded part) of the outer case 103 of a bent structure in which the front part of the flange part and the metal plate is bent with the metal adhesive resin film 106, as shown in FIG. 12, and the bent part of the flange part 103a-1 and the metal plate 104 is thermally bonded together. That is the seal part of the outer case 103 has a rolled structure with a twice-bent shape. This makes it possible to more increase the bonding strength of the seal part composed of the flange part 103a-1, the metal plate 104 and the metal adhesive resin film 106. Accordingly, the structure of the sealed battery shown in FIG. 12 can increase the inner pressure resistance capability against the inner pressure increased when gas is generated in the inside of the concave part of the outer case 103 in which the electric power generating element composed of the electrode body and the electrolyte is stored. It is thereby possible to have a structure to be difficult to separate the flange part 103a-1 from the metal plate 104, and to be difficult to break the outer case 103 and the metal plate 104. Still further, this structure of the flange part 103a-1 and the metal plate 104 is obtained by bending the front part of the flange part and the metal plate twice to make a bent structure and thermally bonding them together. This structure makes it possible to produce the sealed battery almost without increasing the entire weight and manufacturing cost.

By the way, the above structure of the seal part between the outer case 103 and the metal plate 104 is obtained by a rolled structure to bend them twice. The present invention is not limited by this. It is possible to bend the seal part between the flange part and the metal plate not less than three times.

The concept of the sealing structure of the sealed battery shown in FIG. 10 and the sealing structure of the sealed battery shown in FIG. 12 is as follows. The seal part (thermally-bonded part) of the outer case 103 has a structure in which the metal layer composed of the flange part 103a and the metal plate 104 and the metal adhesive resin film 106 are thermally bonded together, and bent one or more times to have a structure of not less than three metal layers, as designated by dotted lines shown in FIG. 10 and FIG. 12. That is, the structure designated by the dotted lines shown in FIG. 10 is composed of the bottom metal layer 104, the metal adhesive resin film 106, the flange part 103a, and the upper metal plate 104 which are stacked in order along a vertical direction.

Further, the structure designated by the dotted lines shown in FIG. 12 is composed of the bottom metal layer 104, the metal adhesive resin film 106, the flange part 103a, the metal adhesive resin film 106, the metal plate 104, the metal adhesive resin film 106, the flange part 103a, the metal adhesive resin film 106 and the upper metal layer 104 which are stacked in order along a vertical direction.

In the above concept of the structure of the sealed battery according to the first exemplary embodiment and the first modification thereof shown in FIG. 10 and FIG. 12, the metal plate 104 is formed on and thermally bonded to each of the bottom surface and the upper surface of the flange parts 103a through the metal adhesive resin film 106. That is, the concept of the structure of the sealed battery according to the present invention is different from the conventional structures in which the metal plate which projects toward the flange part is only bent or the flange part and the metal part are rolled and thermally bonded together.

The structure of the seal part in the sealed battery according to the first exemplary embodiment and the first modification thereof has three or more metal layers. Accordingly, the metal plate is thermally bonded to both the surfaces of the flange part with the metal adhesive resin film 106. In other words, the metal plate, with which the concave part of the outer case 103 is sealed, is thermally bonded to the bottom surface of the flange part 103a through the metal adhesive resin film 106, and the metal plate is thermally bonded on the upper surface of the flange part 103a through the metal adhesive resin film 106. When the seal part has a structure comprised of four, five or more metal layers, the metal plate is thermally bonded on both the upper and bottom surfaces of the flange part through the metal adhesive resin film 106, and a combination of the metal plate, the flange part and the metal adhesive resin film 106 is stacked to produce a lamination structure, and thermally bonded together.

When compared with the conventional sealed structure in which the metal plate is thermally bonded only onto one surface of the flange part through the metal adhesive resin film 106, the structure of the sealed battery according to the first exemplary embodiment and the first modification thereof increases the bonding force between the flange part and the metal plate, and has a resistance against the internal stress generated when gas is generated in the concave part of the outer case 103.

That is, the gas is generated in the electric power generating element stored in the concave part of the outer case 103 and the generated gas increases the inside pressure of the concave part, creeps are generated by the inner pressure and the metal plate is separated from the flange part or the concave part is broken in the conventional sealed battery.

On the other hand, because the sealed battery according to the first exemplary embodiment shown in FIG. 9 and FIG. 10 and the first modification shown in FIG. 12 has the improved sealed structure in which the metal plate is thermally bonded to both the surfaces of the flange part through the metal adhesive resin film 106 and this combination of the metal plate, the flange part and the metal adhesive resin film 106 is stacked to make a lamination structure, it is possible to increase the bonding force between the flange part 103a and the metal plate 104, and to increase the resistance force against the inner pressure generated when gas is generated in the inside of the concave part of the outer case. This structure makes it possible to prevent the flange part from being separated from the metal plate, and to prevent both the flange part and the metal plate from being broken.

Still further, because the structure of the sealed battery according to the first exemplary embodiment and the first modification needs to thermally bond the metal plate 104 to both the surfaces of the flange part at the outer periphery of the outer case, it possible to produce the sealed battery without almost increasing the entire weight and manufacturing cost.

### (Second Modification)

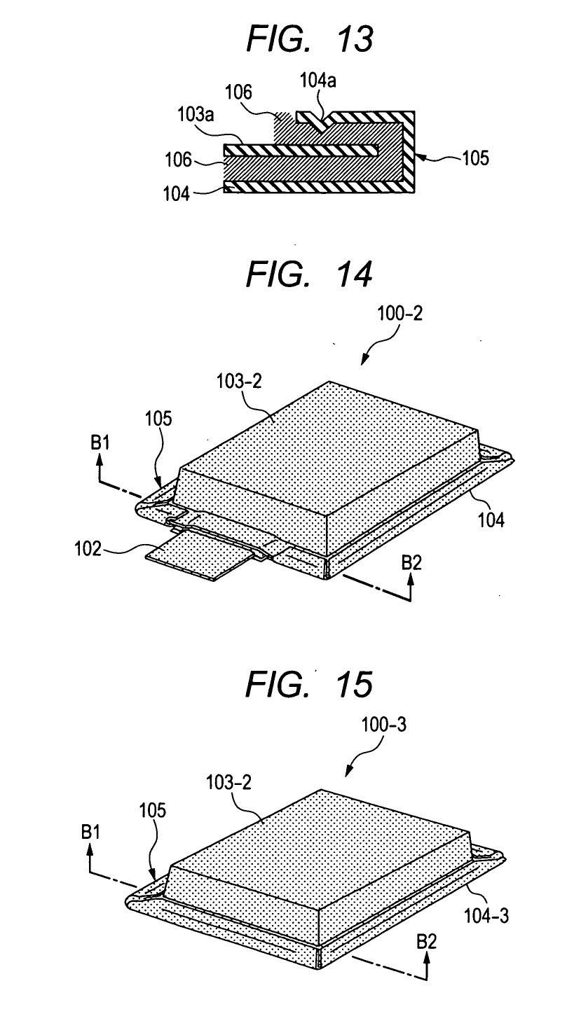

A description will be given of a second modification of the sealed battery according to the first exemplary embodiment of the present invention with reference to FIG. 13.

FIG. 13 is a view showing a cross section of the thermally-bonded part in the flange part of the outer case in the sealed battery as the second modification of the first exemplary embodiment shown in FIG. 9 and FIG. 10.

In the structure shown in FIG. 13, like the first exemplary embodiment shown in FIG. 10, the metal plate 104 is bent toward the upper surface of the flange part 103a and thermally bonded onto the upper surface of the flange part 103a through the metal adhesive resin film 106.

As designated by reference character 104a shown in FIG. 13, a part of the metal plate 104 formed on the upper surface of the flange part 103a through the metal adhesive resin film 106 is caulked to make a concave part on the metal plate 104.

In the structure of the sealed battery having the metal plate with the caulked part 104a shown in FIG. 13, because the seal part of the flange part 103 and the metal part 104 are more strongly bonded together, it is possible to more increase the resistance force against the stress generated when gas is generated in the inside of the concave part of the outer case 103. This can prevent the flange part 103a from being separated from the metal plate 104 or the flange part 103a and the metal part 104 from being broken.

Further, it is possible to make the caulked part 104a on the metal plate 104 at the bottom surface side of the flange part 103a.

Still further, it is possible to make two or more caulked parts on the metal plate 104 at the upper surface side of the flange part 103a (shown in FIG. 13) and on the metal plate 104 at the bottom surface side of the flange part 103a.

Still further, it is possible to make the caulked part 104a in the first modification of the sealed battery shown in FIG. 12.

Still further, it is possible to make two or more caulked parts on the metal plate 104 at the upper surface side of the flange part 103a and on the metal plate 104 at the bottom surface side of the flange part 103a in the sealed battery according to the first modification shown in FIG. 12.

### Second Exemplary Embodiment

A description will be given of the sealed battery 100-2 according to a second exemplary embodiment of the present invention with reference to FIG. 14.

FIG. 14 is a perspective view showing an outer structure of the sealed battery 100-2 according to a second exemplary embodiment of the present invention.

In the structure of the sealed battery 100-2 according to the second exemplary embodiment of the present invention shown in FIG. 14, the outer case 103-2 also acts as the positive electrode lead. This structure is different from the structure of the sealed battery 100-1 according to the first exemplary embodiment shown in FIG. 9. That is, the positive electrode lead is not projected from the sealed battery 100-2 according to the second exemplary embodiment. On the other hand, as shown in FIG. 14, the negative electrode lead 102 is projected from the outer case 103-2.

The structure of the sealed battery 100-2 according to the second exemplary embodiment makes it possible to decrease the manufacturing cost, the entire weight of the sealed battery and the total number of components forming the sealed battery because the sealed battery 100-2 according to the second exemplary embodiment does not require the positive electrode lead and the outer case 103-2 acts as the positive electrode lead when compared with the structure and the manufacturing cost of the sealed battery according to the first exemplary embodiment.

In the sealed battery 100-2 according to the second exemplary embodiment, it is also possible for the outer case to act as the negative electrode lead instead of the positive electrode lead. In this structure, the positive electrode lead is projected only from the outer case 103-2.

### Third Exemplary Embodiment

A description will be given of the sealed battery 100-3 according to a third exemplary embodiment of the present invention with reference to FIG. 15.

FIG. 15 is a perspective view showing an outer structure of the sealed battery 100-3 according to the third exemplary embodiment of the present invention.

In the structure of the sealed battery 100-3 according to the third exemplary embodiment of the present invention as shown in FIG. 15, the metal plate 104-3 acts as the negative electrode lead, and in addition to this, the outer case 103-2 acts as the positive electrode lead. That is, the negative electrode lead is not projected from the sealed battery 100-3, like the positive electrode lead. This structure of the sealed battery 100-3 according to the third exemplary embodiment decreases the manufacturing cost to produce the positive electrode lead and the negative electrode lead and decreases the total number of components forming the sealed battery because the metal plate 104-3 acts as the negative electrode lead and the outer case 103-2 acts as the positive electrode lead, when compared with these of the sealed batteries according to the first exemplary embodiment and the second exemplary embodiment.

Further, it is also possible that the metal plate 104-3 acts as the positive electrode lead 101 and the outer case 103-2 acts as the negative electrode lead 102.

### Fourth Exemplary Embodiment

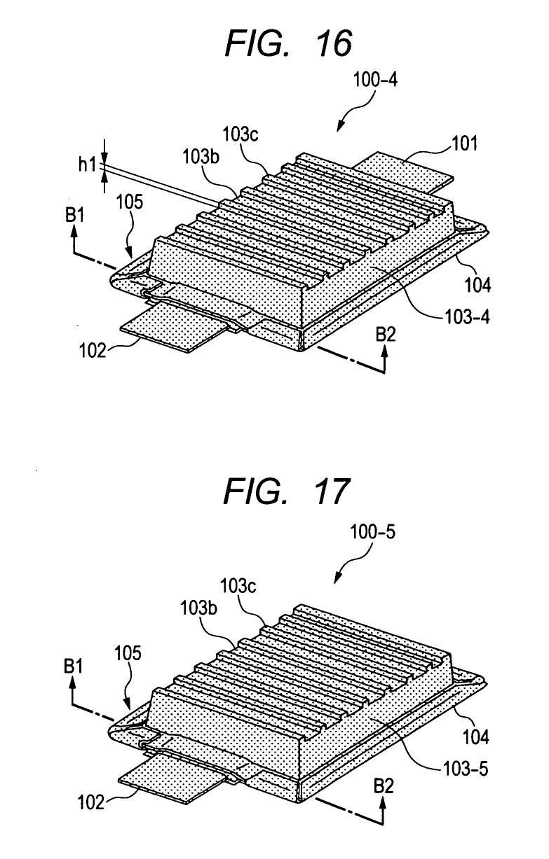

A description will be given of the sealed battery 100-4 according to a fourth exemplary embodiment of the present invention with reference to FIG. 16.

FIG. 16 is a perspective view showing an outer structure of the sealed battery 100-4 according to the fourth exemplary embodiment of the present invention.

In the structure of the sealed battery 100-4 according to the fourth exemplary embodiment of the present invention as shown in FIG. 16, the surface of the outer case 103-4, which is opposite to the surface of the metal plate 104 has an uneven shape composed of column-shaped concave parts 103b and column-shaped convex parts 103c which are alternately arranged from one side to the other side of the outer case 103-4. The column-shaped concave parts 103b and the column-shaped convex parts 103c ate arranged in parallel on the surface of the outer case 103-4 shown in FIG. 16. In other words, the column-shaped concave parts 103b and the column-shaped convex parts 103c are alternately formed on the outer case 103-4 from one side to the other side thereof.

This structure of the sealed battery 100-4 according to the fourth exemplary embodiment has an improved radiation effect or a cooling capability because the surface of the outer case 103-4 has an uneven surface on which the column-shaped concave parts 103b and the column-shaped convex parts 103c are alternately formed, and this structure increases the entire surface area of the surface of the outer case 103-4. Having such an improved radiation effect can suppress the bonding force between the metal plate 104 and the flange part 103a of the outer case 103-4 from being decreased.

In particular, it is preferable that the height h1 of each of the column-shaped convex parts 103c is within a range of 0.1 mm to 2.0 mm. This makes it possible to suppress the entire volume of the sealed battery from being increased while maintaining the above improved radiation effect.

### Fifth Exemplary Embodiment

A description will be given of the sealed battery 100-5 according to a fifth exemplary embodiment of the present invention with reference to FIG. 17.

FIG. 17 is a perspective view showing an outer structure of the sealed battery 100-5 according to a fifth exemplary embodiment of the present invention.

In the structure of the sealed battery 100-5 according to the fifth exemplary embodiment shown in FIG. 17, the outer case 103-5 also acts as the positive electrode lead 101 and the outer case 103-5 has the uneven surface like the structure of the outer case 103-4 shown in FIG. 16. That is, the positive electrode lead 101 is not projected from the sealed battery 100-5 and the outer case 103-5 has the function of the positive electrode lead 101.

This structure of the sealed battery 100-5 according to the fifth exemplary embodiment shown in FIG. 17 can decrease the manufacturing cost to produce the positive electrode lead, and decrease the entire weight of the sealed battery and the total number of components forming the sealed battery because the sealed battery 100-5 according to the fifth exemplary embodiment does not require the positive electrode lead, and the outer case 103-5 acts as the positive electrode lead.

It is also possible that the outer case 103-5 acts as the negative electrode lead which is not projected from the outer case 103-5. In this structure, the positive electrode lead is projected only from the outer case 103-5.

### Sixth Exemplary Embodiment

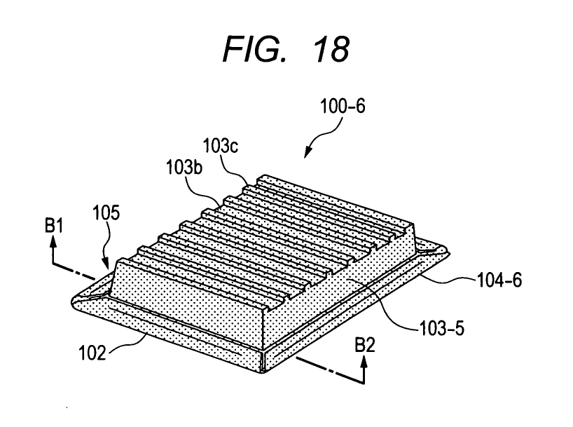

A description will be given of the sealed battery 100-6 according to a six exemplary embodiment of the present invention with reference to FIG. 18.

FIG. 18 is a perspective view showing an outer structure of the sealed battery 100-6 according to the sixth exemplary embodiment of the present invention.

In the structure of the sealed battery 100-6 according to the sixth exemplary embodiment of the present invention shown in FIG. 18, the metal plate 104-6 acts as the negative electrode lead 102 and the outer case 103-5 acts as the positive electrode lead. That is the negative electrode lead 102 is not projected from the sealed battery 100-6, as well as the positive electrode lead. This structure of the sealed battery 100-6 according to the sixth exemplary embodiment decreases the manufacturing cost to produce the positive electrode lead and the negative electrode lead and decreases the total number of components forming the sealed battery because the metal plate 104-6 acts as the negative electrode lead and the outer case 103-5 acts as the positive electrode lead, when compared with these of the sealed batteries according to the fourth exemplary embodiment and the fifth exemplary embodiment.

Further, it is also possible that the metal plate 104-6 acts as the positive electrode lead 101 and the outer case 103-5 acts as the negative electrode lead 102.

It is preferable to apply the sealed battery according to each of the first to sixth exemplary embodiments and the modifications thereof to a field of lithium ion secondary batteries in order to have the same actions and effects of the sealed battery according to the present invention.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A sealed battery comprising:
an electric power generating element comprised of an electrode body, electrolyte and a positive electrode and a negative electrode;
a positive electrode lead electrically connected to the positive electrode and a negative electrode lead electrically connected to the negative electrode;
an outer case made of metal, having a flange part and a concave part, the flange part extending from the outer periphery of the outer case to the outside thereof, and the concave part storing the electric power generating element; and
a metal plate configured to cover the concave part of the outer case in order to seal the concave part, and the metal plate and the flange part being thermally bonded together through a metal adhesive resin film placed between the surface of the flange part and the metal plate,
wherein the thermally-bonded part between the metal plate and the flange part of the outer case has a lamination structure in which the metal plate is comprised of at least not less than three metal layers, and the flange part and the metal layer are alternately stacked through the metal adhesive resin film.

2. A sealed battery comprising:
an electric power generating element comprised of an electrode body, electrolyte and a positive electrode and a negative electrode;
a positive electrode lead electrically connected to the positive electrode and a negative electrode lead electrically connected to the negative electrode;
an outer case made of metal, having a flange part and a concave part, the flange part extending from the outer periphery of the outer case to the outside thereof, and the concave part storing the electric power generating element; and
a metal plate configured to cover the concave part of the outer case in order to seal the concave part, and the metal plate and one surface of the flange part being thermally bonded together through a metal adhesive resin film placed between the surface of the flange part and the metal plate,
wherein the metal plate projects toward the outside of the flange part, and the projected part of the metal part with the metal adhesive resin film is bent toward the other surface of the flange part, and the bent part of the metal part and the other surface of the flange part are thermally bonded through the metal adhesive resin film.

3. The sealed battery according to claim 1, wherein the metal plate and the outer case are made of one metal selected from aluminum, stainless steel, copper, nickel, and nickel plated copper.

4. The sealed battery according to claim 3, wherein the metal plate and the outer case have a thickness within a range of 0.1 mm to 2.0 mm.

5. The sealed battery according to claim 1, wherein the surfaces of the metal plate and the flange part are made of one metal selected from chromate-treated metal, alumite treated metal, boehmite treated metal.

6. The sealed battery according to claim 1, wherein the metal adhesive resin film is acid modified polyolefin resin.

7. The sealed battery according to claim 2, wherein the thermally-bonded part between one surface of the flange part and the metal plate which is bent toward one surface direction is further bent toward the other surface of the flange part and rolled with the metal adhesive resin film at least one or more times and thermally bonded together.

8. The sealed battery according to claim 1, wherein the surface of the metal plate thermally bonded to the surface of the flange part is caulked.

9. The sealed battery according to claim 1, wherein the outer case is electrically connected to one of the positive electrode and the negative electrode of the electrode body, and the electrode lead connected to the other electrode is extended from the concave part of the outer case toward the outside of the sealed battery.

10. The sealed battery according to claim 1, wherein the outer case is electrically connected to one of the positive electrode and the negative electrode of the electrode body, and the metal plate is electrically connected to the other electrode.

11. The sealed battery according to claim 1, wherein one surface of the outer case, which faces to the metal plate, has an uneven shape.

12. The sealed battery according to claim 11, wherein the uneven shape of the surface of the outer case is composed of a plurality of column-shaped concave parts and column-shaped convex parts, and a height of each of the column-shaped convex parts is within a range of 0.1 mm to 2.0 mm.

13. The sealed battery according to claim 1, wherein the sealed battery is a lithium ion secondary battery.
